(19) United States
(12) Patent Application Publication
(10) Pub. No.: US 2026/0109073 A1
(43) Pub. Date: Apr. 23, 2026

(54) HAND-HELD POWER TOOL AND METHOD FOR OPERATING A HAND-HELD POWER TOOL

(71) Applicant: Festool GmbH, Wendlingen (DE)

(72) Inventors: Daniel SCHÄUBLE, Neckartailfingen (DE); Arne HOLTZ, Köngen (DE); Timo BAYER, Tübingen (DE); Matthias KÜBELER, Kichheim unter Teck (DE)

(21) Appl. No.: 19/148,236

(22) PCT Filed: Jan. 16, 2025
(86) PCT No.: PCT/EP2025/051074

§ 371 Date: Jul. 15, 2025

(30) Foreign Application Priority Data
Jan. 17, 2024 (DE) 10 2024 101 338.9

(51) Int. Cl. B27C 5/10; B23Q 11/00

(52) U.S. Cl. CPC B27C 5/10; B23Q 11/006

(57) ABSTRACT

A hand-held power tool, in particular woodworking tool, including a housing, a handle for positioning the power tool relative to a workpiece, a reciprocating unit for holding a tool for machining a workpiece, a drive module located in the housing for driving the reciprocating unit, and a pressurized fluid dispensing assembly having an outlet area for dispensing gaseous pressurized fluid into a working area of the tool during machining of the workpiece with the tool to purge the working area to cause and/or assist a conveyance of workpiece particles from the formed depression.

### BACKGROUND OF THE INVENTION

The invention relates to a hand-held power tool, in particular a woodworking tool, comprising: a housing, a handle for positioning the power tool relative to a workpiece, a reciprocating unit for holding a tool for machining a workpiece and a drive module located in the housing for driving the reciprocating unit.

Hand-held power tools are known from the prior art. For example, hand-held power tools exist in the form of a hand-held milling machine for milling a cavity in the form of an elongated hole in a workpiece, as known from DE 10 2011 103 014 A1.

When machining a workpiece, for example when making a cavity in a panel-shaped workpiece made of wood and/or composite material, workpiece particles, in particular dust and chips, are regularly produced, which can sometimes contribute to contamination of the cavity, a working area or an environment, which can also impair the functionality or operability of the power tool. Vacuum assemblies, which are intended to extract the workpiece particles produced during machining, have a limited depth of action up to which the workpiece particles that are produced or present in the cavity are captured by a suction flow. Consequently, workpiece particles remain in areas that are not captured by the suction flow, particularly in the cavity. There, such workpiece particles can negatively influence the machining result by inhibiting the movement of the tool and impairing the dimensional accuracy of the cavity. By inhibiting the movement of the tool, there is also a risk that a driving force of the drive module is transmitted to a user of the power tool, which can cause injury to the user and/or slow down the movement of the power tool relative to the workpiece, thereby unnecessarily extending the machining time.

Another problematic aspect can be that the workpiece particles remaining in the cavity continue to be cut by the tool and thus leading to increased wear of the tool. The remaining workpiece particles can also cause injury if a person wants to clean the machined workpiece from the workpiece particles.

### SUMMARY OF THE INVENTION

On this basis, it is an object of the present invention to provide an improved hand-held power tool of the type mentioned at the beginning, which in particular overcomes at least one of the above-mentioned problems.

According to the invention, this task is solved by a hand-held power tool having the features specified in claim 1. Preferred and advantageous embodiments of the power tool according to the invention are set forth in the dependent claims.

The power tool according to the invention comprises a pressurized fluid dispensing assembly having an outlet area for dispensing gaseous pressurized fluid into a working area of the tool during machining of the workpiece with the tool to purge the working area with the gaseous pressurized fluid.

In particular, the working area is understood to be the area in which the tool performs the movement intended for machining the workpiece, the space located between the housing of the power tool and the workpiece during machining and/or the space between the housing of the power tool and a guiding unit of the power tool. Purging with gaseous pressurized fluid removes workpiece particles from at least a section of the working area and prevents the power tool from malfunctioning.

In this context, an outlet area is understood to mean in particular at least one outlet opening through which pressurized fluid can exit, with the outlet opening preferably having an outlet cross-sectional area.

The pressurized fluid can be dispensed continuously or intermittently during the machining of the workpiece, whereby the start or stop of dispensing of pressurized fluid can be done by a user, for example by actuating a corresponding switch or opening/closing a valve, and/or by a control provided in the power tool.

The pressurized fluid dispensing assembly can be integrated in the power tool or can be designed as a modular, retrofittable system that can be connected to a power tool, for example by the pressurized fluid dispensing assembly having a frame structure that can be connected to the housing of the power tool.

In particular, at least one electric motor is provided as the drive module, which is supplied by a voltage source in the form of a power connection or a rechargeable battery, preferably located on or in the housing. It is also possible for the drive module to have a first electric motor, which may also be referred to as a drive motor, and at least one second electric motor, which may also be referred to as a servomotor.

Preferably, the hand-held power tool further comprises the tool, wherein the tool serves to produce a cavity, in particular a hole and/or a groove, in the workpiece and the pressurized fluid dispensing assembly serves to dispense the gaseous pressurized fluid into the resulting cavity during the production of the cavity in order to cause and/or support a conveyance of workpiece particles from the resulting cavity. For this purpose, the outlet area is located in particular in such a way that the outlet opening is oriented in the direction of the workpiece and/or the resulting cavity. The orientation of the outlet opening is understood in particular to be the direction of the normal vector of the outlet cross-sectional area directed in the outlet direction of the pressurized fluid. The resulting cavity has a base surface oriented essentially parallel or at an angle to a surface of the workpiece, which is connected to the surface of the workpiece via a side surface, which can also be formed from several surfaces. By dispensing the pressurized fluid into the resulting cavity, workpiece particles located within the resulting cavity can be completely removed from the cavity or at least removed from the area of the cavity in which the tool performs the machining of the workpiece. This reduces the amount of workpiece particles that remain in the cavity or removes the workpiece particles almost completely from the cavity. Preferably, the tool is a milling cutter, in particular a wood milling cutter.

In a further preferred embodiment, the power tool comprises a vacuum assembly for extracting workpiece particles from the working area. The vacuum assembly preferably comprises at least one suction nozzle, which is designed for connection to a suction device, in particular in the form of a vacuum cleaner, and a suction opening. The suction opening is preferably oriented in the direction of the working area in order to extract workpiece particles located in the working area. In a particularly preferred embodiment, the suction opening is positioned opposite the outlet region, so that the tool and/or the reciprocating unit is located between the suction opening and the outlet area. By means of the suction unit, the workpiece particles purged from the working area or conveyed from the resulting cavity can be removed further, so that the amount of workpiece particles in the working area or in the cavity as well as the amount of workpiece particles entering the environment can be further reduced.

Preferably, the power tool further comprises a guiding unit with an abutment surface for abutment against the workpiece, wherein the pressurized fluid dispensing assembly is preferably located on and/or in the guiding unit. The guiding unit is preferably connected to the housing via a linear guide, which enables the housing to be displaced relative to the guiding unit. In this way, when the abutment surface is in contact with the surface of the workpiece, the position of the tool relative to the workpiece surface can be adjusted. Alternatively, the linear guide can be permanently connected to the housing. In this case, the position of the tool relative to the workpiece surface can be adjusted via a displacement unit provided for this purpose, in particular in the form of a CNC displacement unit. The displacement unit can be designed separately or integrated into or connected to the movement unit. In addition, the displacement unit enables linear displacement of the tool in any spatial direction relative to the workpiece surface. In this context, it can also be referred to as a 3-axis milling machine, in particular a hand-held one. Preferably, the abutment surface is made in several parts and comprises at least a first section and a second section, wherein the second section is connected to the guiding unit by an angle adjustment mechanism in order to be able to set an angle between the first section and the second section. The abutment surface can also be table-shaped or plate-shaped.

Preferably, the abutment surface has a recess through which the tool extends for machining the workpiece, with the outlet area of the pressurized fluid dispensing assembly being located in the area of the recess. The recess has an inlet edge directed towards the reciprocating unit and an outlet edge connected to the inlet edge via a lateral surface and directed towards the workpiece, with the outlet area preferably being located in the area of the inlet edge, i.e., between the housing and the abutment surface.

The outlet area is thus protected from damage by the abutment surface or the guiding unit. For an effective dispense of pressurized fluid into the resulting cavity, the outlet opening or the outlet cross-sectional area can be oriented towards the outlet edge and/or the resulting cavity and, for example, dispense the pressurized fluid tangentially, in particular to the side wall of the cavity, into the resulting cavity. In other words, the outlet area of the pressurized fluid dispensing assembly is designed such that a dispensing of pressurized fluid takes place parallel to a central axis of the tool and/or to a central axis of the reciprocating unit.

In a preferred embodiment of the power tool, the outlet area of the pressurized fluid dispensing assembly is fixed in position relative to, in, or on the guiding unit. In particular, this means that the outlet area is stationary during processing of the workpiece and a distance between the outlet area and the tool does not change. The stationary arrangement enables a simple design of the pressurized fluid dispensing assembly.

Preferably, the outlet area of the pressurized fluid dispensing assembly is movably arranged relative to, in or on the guiding unit. A movable arrangement makes it possible to adjust the position of the outlet area to the tool to be used and/or to the geometry of the cavity. For example, it is conceivable that the distance between the outlet area and the tool can be set larger for a cavity in the form of a groove than for a cavity in the form of a bore. The distance of the outlet area in the vertical direction of the abutment surface can also be adjusted so that the outlet area is positioned closer to or further away from the workpiece surface during machining.

Preferably, the drive module is designed to set the reciprocating unit into an operation movement to move the tool relative to the workpiece. In particular, an operation movement is understood to be a movement relative to the workpiece or the workpiece surface, whereby the movement comprises components parallel and/or perpendicular to the workpiece surface. As an example, the reciprocating unit has a spindle performing a rotational movement and the displacement unit. The tool is accommodated in the spindle and is driven to a rotational movement for machining the workpiece, whereby the spindle is connected to the displacement unit in order to be displaceable relative to the workpiece. The drive motor is provided to drive the spindle and the servomotor is provided to drive the displacement unit. A rotational movement is understood to mean a rotation of the tool about the central axis of the tool.

Advantageously, the outlet area is at least temporarily motion-coupled to the reciprocating unit, so that the outlet area is set into an outlet area movement relative to the guiding unit by the operation movement or part of the operation movement. The motion coupling between the outlet area and the tool makes it possible to minimize the distance between the outlet area and the tool in order to allow the most effective possible dispense of pressurized fluid into the resulting cavity without restricting the operation motion of the reciprocating unit, in particular the component parallel to the workpiece surface.

Particularly preferably, the reciprocating unit comprises a spindle mount executing the operation movement and the spindle executing the rotational movement, the spindle being located at least in sections within the spindle mount.

Further preferably, the pressurized fluid dispensing assembly is motion-coupled to the spindle mount via a coupling unit, in particular a cam disk coupling. In this case, the spindle mount is in contact with a correspondingly designed curve segment of the coupling unit during the operation movement or part of the operation movement, whereby the curve segment, which is connected at least to the outlet area, can be spring-loaded in order to allow a return movement of the outlet area to an initial position. The initial position can be any position of the outlet area in the recess, which enables the dispense of pressurized fluid, in particular through the recess of the abutment surface. Preferably, the dispensing of pressurized fluid is interrupted when the outlet area is temporarily located outside the area of the recess due to the outlet area movement. The coupling unit can also be used to allow motion coupling for operation movements that have a complex path geometry, for example a back and forth oscillating movement on a circular path section.

In a further embodiment of the power tool, the outlet area has an outlet opening that opens out of the tool. The outlet opening is preferably located on the end face or circumference of the tool and is oriented parallel and/or perpendicular to a channel formed in the tool and extending in the longitudinal direction of the tool and is fluidically connected thereto. Further preferably, the outlet opening can be located in a tool tip segment and/or an area different from the tool tip segment, in particular an area adjacent to the tool tip segment and/or on the periphery of the tool, in particular in a chip space of the tool, wherein advantageously the tool tip segment is made of a material different from a base material of the tool, in particular of a carbide. Due to the arrangement of the outlet opening in the tool, the gaseous pressurized fluid can be dispensed directly into the resulting cavity.

Preferably, the power tool further comprises a pressurized fluid source that is fluidically connected to the pressurized fluid dispensing assembly and serves to provide the pressurized fluid to the pressurized fluid dispensing assembly. By way of example, the pressurized fluid source can be formed by a first element of a coupling, in particular a quick coupling, which can be connected to a second element of the coupling located on a pressurized fluid conduit in order to provide a volume flow of pressurized fluid from the pressurized fluid conduit of the pressurized fluid dispensing assembly. As an example, the pressurized fluid source can comprise an external supply unit which has a compressor or a pressurized fluid container and is fluidically connected to the pressurized fluid dispensing assembly, for example via a pressurized fluid conduit. The pressurized fluid dispensing assembly preferably has a quick-connect element for this purpose. The supply unit can also have a suction device that is fluidically connected to the vacuum assembly. It is advantageous to provide a volume flow of pressurized fluid of at least 20 l/s, preferably at least 35 l/s, in order to ensure sufficient purging of the working area or to effect and/or support the removal of workpiece particles from the resulting cavity or the working area when the gaseous pressurized fluid is dispensed.

In an advantageous embodiment of the power tool, the pressurized fluid source is located in or on the housing or the guiding unit, in particular in a fixed position. These arrangement options improve the mobility of the power tool and the workpiece can be machined independently of an external supply unit. This can also be referred to as self-sufficient machining.

Preferably, the pressurized fluid source comprises a fluid reservoir. The fluid reservoir serves as a pressurized fluid reservoir and enables, for example, the provision of pressurized fluid if the power tool is not supplied by a pressurized fluid conduit, for example due to a temporary failure of the pressurized fluid conduit or if the power tool is to be used at a location remote from the pressurized fluid conduit. The fluid reservoir can already be filled with pressurized fluid or can be filled during operation by directing part of the volume flow of the pressurized fluid into the fluid reservoir. The fluid reservoir can also have a valve unit, in particular in the form of a shut-off valve and/or a pressure relief valve, in order to prevent the pressurized fluid from escaping from the fluid reservoir after it has been completely filled or to prevent further filling with pressurized fluid. It is also possible to release the pressure if the pressure of the pressurized fluid exceeds a permissible value, for example as a result of a malfunction or severe heating of the power tool or the fluid reservoir.

In a further embodiment of the power tool, the fluid reservoir is designed as a replaceable cartridge. By means of the replaceable cartridge, which is filled with pressurized fluid, the power tool can be used over a longer period of time independently of a pressurized fluid conduit by replacing the cartridge with a new one after the current cartridge has been emptied. The replaceable cartridge also enables the use of different gases as gaseous pressurized fluid. For example, a shielding gas such as nitrogen or argon can also be used if the material of the workpiece or the environment in which the workpiece is being processed requires this.

Advantageously, the pressurized fluid source comprises a compressor. The compressor, which can be located in or on the housing or in or on the guiding unit, enables self-sufficient processing of the workpiece over a longer period of time. The compressor can be designed as a separate unit that has its own drive, in particular an electric motor, and its own voltage source. It is also possible to design it as an integrated unit that is also driven by the drive module of the power tool.

Furthermore, the power tool can comprise a barrier device that is designed to discharge gaseous pressurized fluid to provide a barrier fluid flow. The barrier device comprises a discharge opening having a discharge cross-sectional area, which is located such that a main flow direction of the barrier fluid flow is substantially parallel to the surface of the workpiece. The barrier fluid flow can support the transportation of workpiece particles in the working area and thus prevent workpiece particles from leaving the working area in an uncontrolled manner. In particular, uncontrolled is understood to mean leaving the working area in the direction of the housing or in the direction of a user guiding the power tool. Preferably, the discharge opening is oriented in the direction of the suction opening in order to further improve the transport of the workpiece particles out of the working area.

The above task is also solved by a method for operating a hand-held power tool according to the invention. The method comprises the steps of: Machining the workpiece with the tool in the working area, dispensing gaseous pressurized fluid into the working area of the tool while machining the workpiece with the tool to purge the working area with the gaseous pressurized fluid.

Furthermore, the above-mentioned task is also solved by a woodworking tool, in particular a wood milling cutter, with a channel extending along a central axis and an outlet opening fluidically connected to the channel for dispensing gaseous pressurized fluid into a working area. In particular, the woodworking tool has a first tool segment, a second tool segment with a tool tip segment and a pressurized fluid inlet chamber connected to the outlet opening via the channel.

The tool tip segment forms the end section of the second tool segment opposite the first tool segment. The second tool segment is designed, at least in certain areas, for machining a wooden workpiece. In particular, the second tool segment has cutting edges located on the circumference and extending in the longitudinal direction of the central axis. The tool tip segment is designed for machining a wooden workpiece and extends from an end face of the woodworking tool along the central axis of the woodworking tool. The end face of the tool tip segment can have cutting edges extending in a radial direction.

The cutting edge extending in the longitudinal direction preferably runs in a spiral shape, wherein an angle resulting from the spiral shape of the cutting edge, which can also be referred to as a spiral angle, between the cutting edge and the central axis of the woodworking tool is preferably 10° to 15°, particularly preferably 11° to 12°, wherein the spiral angle in the region of the tool tip segment can be greater, particularly by 0.5° to 1°, than the spiral angle in the remaining region of the second tool segment. A tool for woodworking designed as described can also be referred to as a spiral milling cutter.

Advantageously, the tool tip segment is made of a material different from a base material of the woodworking tool, in particular of a cemented carbide. Preferably, the woodworking tool has two and more preferably three cutting edges distributed at a uniform angular spacing around the circumference of the woodworking tool. The end face may be formed by a surface oriented substantially perpendicular to the central axis of the woodworking tool and/or by a plurality of cutting edges, wherein all or some of the plurality of cutting edges may not be oriented perpendicular to the central axis of the woodworking tool.

The outlet opening is located on the end face and/or circumference of the woodworking tool and is oriented parallel and/or perpendicular to the channel formed in the woodworking tool.

Preferably, the outlet opening is located in a region of the second tool segment that is different from the tool tip segment, wherein in particular the tool tip segment is made of a material that is different from a base material of the woodworking tool, in particular of a cemented carbide. Due to the arrangement of the outlet opening in the woodworking tool, the gaseous pressurized fluid can be dispensed directly into the resulting cavity. Furthermore, during manufacture, the channel can be introduced into an area of the woodworking tool that is easy to machine, while the areas of the cutting edges that are subject to heavy wear are made of a resistant material in the area of the tool tip segment.

Alternatively, it may be provided that the channel is located in an area of the woodworking tool made of cemented carbide. In particular, the woodworking tool can be made entirely of cemented carbide.

### BRIEF DESCRIPTION OF THE DRAWINGS

In the following, preferred embodiments of the invention are explained in more detail with reference to the accompanying drawing. The drawing shows.

FIG. 1 a first embodiment of a hand-held power tool according to the invention in a perspective view from behind,

FIG. 2 a first embodiment of a hand-held power tool according to the invention in a perspective view from the front,

FIG. 3 a sectional view of a reciprocating unit of the power tool with a tool, a vacuum assembly and a first embodiment of a pressurized fluid dispensing assembly in a side view,

FIG. 4 a sectional view of the reciprocating unit, the vacuum assembly and a second version of a pressurized fluid dispensing assembly in a side view,

FIG. 5a a sectional view of an alternative reciprocating unit of a second embodiment of the hand-held power tool in a first position, the vacuum assembly and a third embodiment of a pressurized fluid dispensing assembly in a side view,

FIG. 5b a sectional view of the reciprocating unit from FIG. 5a in a second position, the vacuum assembly and the design of the pressurized fluid dispensing assembly from FIG. 5a in a side view,

FIG. 5c a sectional view of the reciprocating unit from FIG. 5a in a third position, the vacuum assembly and the design of the pressurized fluid dispensing assembly from FIG. 5a in a side view,

FIG. 6a a side view of the pressurized fluid dispensing assembly from FIG. 5a,

FIG. 6b a sectional view of the pressurized fluid dispensing assembly of FIG. 6a in a side view,

FIG. 7 a sectional view of a section of a third embodiment of the hand-held power tool with a fourth embodiment of a pressurized fluid dispensing assembly in a side view,

FIG. 8a a sectional view of a first embodiment of a tool for woodworking with an outlet area in a side view,

FIG. 8b a sectional view of a second embodiment of a woodworking tool with an outlet area in a side view,

FIG. 8c a sectional view of a third embodiment of a tool for woodworking with an outlet area in a side view,

FIG. 9a a fourth embodiment of a woodworking tool with outlet area in a side view and

FIG. 9b sectional view along the cutting plane A-A of the embodiment of the tool from FIG. 9a in a plan view.

### DETAILED DESCRIPTION OF THE INVENTION

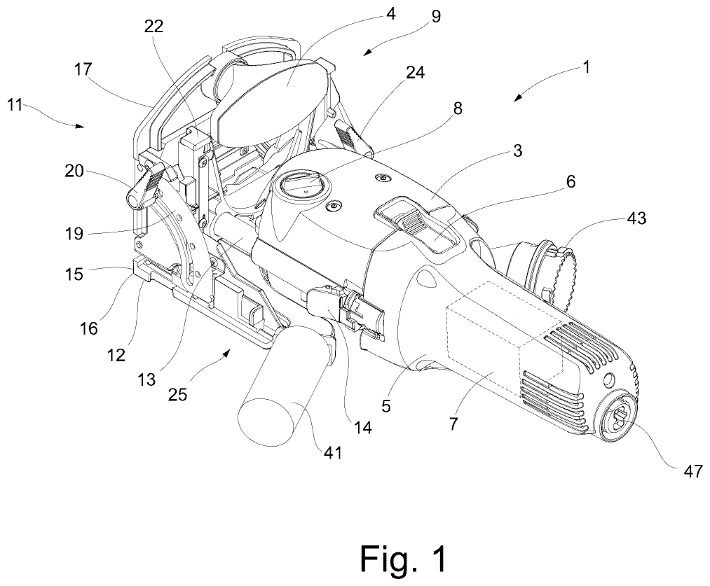

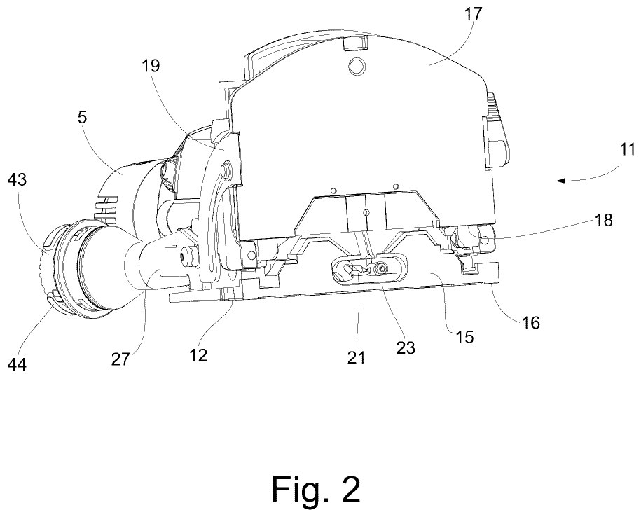

FIGS. 1 and 2 show a first embodiment of a hand-held power tool 1 according to the invention. The power tool 1 comprises a housing 3, a guide handle 4 and a handle 5 for positioning the power tool 1 relative to a workpiece not shown, a drive module 7 located in the housing 3 and a guiding unit 9.

In the area of the handle 5, an activation button 6 is located on an upper side of the housing 3, with which the power tool 1 can be switched on and off.

Furthermore, an adjusting element 8 is located on the upper side of the housing 3 in the area between the activation button 6 and the guiding unit 9. The guiding unit 9 has an abutment surface 11 with which the guiding unit 9 can be brought into contact with a surface of the workpiece to be machined.

The abutment surface 11 of the illustrated guiding unit 9 is made of several parts and comprises a first section 15 and a second section 17, wherein the second section 17 is connected to the guiding unit 9 via an angle adjustment mechanism 19 in order to be able to set an angle between the first section 15 and the second section 17. The guide handle 4 is located at an end of the second section 17 facing away from the first section 15. A setting is shown in which the angle between the first section 15 and the second section 17 is 180°. Preferably, the angle can be set in a range from 90° to 180°. To fix the set angle, the angle adjustment mechanism 19 has a first locking piece 20. A lower edge 16 of the first section 15, i.e., the edge of the first section 15 facing away from the second section 17, is adjoined by a floor abutment surface 12, which is oriented substantially perpendicular to the first section 15 of the abutment surface 11. Adjusting a distance between an edge 18 of the second section 17 facing the first section 15 in a direction perpendicular to the floor abutment surface 12, which can also be referred to as a vertical direction, is possible via a vertical guide means 22. This is particularly advantageous if the angle between the first section 15 and the second section 17 is 90° and the second section 17 is brought into contact with a surface of a workpiece to be machined, for example to machine an end face of the workpiece. A second locking element 24 is provided to fix the set distance between the edge 18 and the floor abutment surface 12.

The guiding unit 9 is connected to the housing 3 via a linear guide 13, which enables the housing 3 to be displaced relative to the guiding unit 9. Such a displacement can also be referred to as a displacement in the longitudinal direction.

A tool 21 serving to produce a cavity in the workpiece extends through a recess 23 formed in the first section 15 of the abutment surface 11, wherein a distance between the workpiece-side end of the tool 21, which can also be described as a milling cutter tip by way of example, and the first section 15 of the abutment surface 11 can be varied, at least during machining of the workpiece, by moving the tool 21 in a direction perpendicular to the first section 15 when the abutment surface 11 is in contact with the workpiece, at least in sections. For example, the housing 3 is moved along the linear guide 13 of the guiding unit 9 in the direction of the abutment surface 11 or in the opposite direction. The maximum distance between the workpiece-side end of the tool 21 and the first section 15 of the abutment surface 11 can be preset by a depth adjustment mechanism 14, which limits the maximum displacement along the linear guide 13.

Furthermore, a pressurized fluid dispensing assembly 25 and a vacuum assembly 27 are located on the guiding unit 9. The pressurized fluid dispensing assembly 25 with an outlet area 29 is designed to dispense gaseous pressurized fluid into a working area of the tool 21 in order to purge the working area with the gaseous pressurized fluid during machining of the workpiece or to dispense pressurized fluid into the resulting cavity. At the end of the pressurized fluid dispensing assembly 25 facing away from the outlet area 29, a pressurized fluid source 41 is located, as can be seen in particular in FIG. 1, which is fluidically connected to the pressurized fluid dispensing assembly 25 and is exemplarily designed in the form of a cylindrical cartridge. A working area is understood to be the area in which the tool 21 performs the movement intended for machining a workpiece, the space between the housing 3 of the power tool 1 and the workpiece during machining, and the space between the housing 3 of the power tool 1 and a guiding unit 9. Purging with gaseous pressurized fluid removes workpiece particles from at least a section of the working area and prevents the functionality of the power tool 1 from being impaired. The workpiece particles are transported further by the vacuum assembly 27, wherein the vacuum assembly 27 has a suction nozzle 43 for connecting the vacuum assembly 27 to a suction device not shown and a suction opening 45, which is located opposite the outlet area 29 in the present case. The suction nozzle 43 located at an end of the vacuum assembly 27 opposite the suction opening 45 has latching elements 44 located on the circumference for connection to the suction device not shown. In this way, a connecting nozzle of the suction device can be latched to the suction nozzle 43 as an example.

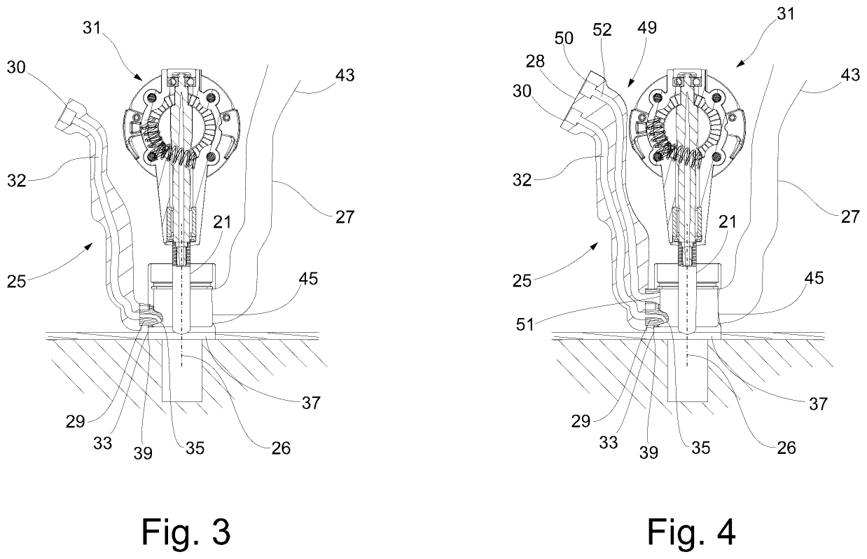

The first embodiment of the pressurized fluid dispensing assembly 25, a tool 21 and the vacuum assembly 27 are shown in FIG. 3. The outlet area 29 of the vacuum assembly 27 is stationarily fixed on the guiding unit 9 in the area of an inlet edge 33 of the recess 23, wherein an outlet opening 35 of the outlet area 29 is oriented in the direction of an outlet edge 39 of the recess 23 connected to the inlet edge 33 via a lateral surface 37. For fluidic connection of the pressurized fluid dispensing assembly 25 to the pressurized fluid source 41, the pressurized fluid dispensing assembly 25 has an inlet area 30 at its end opposite the outlet area 29. The inlet area 30 is fluidically connected to the outlet area 29 via a pressurized fluid channel 32. For the removal or further transport of the workpiece particles captured or whirled up by a pressurized fluid flow, the suction opening 45 of the vacuum assembly 27 is oriented in the direction of the working area and thus, by way of example, oriented perpendicular to a central axis 26 of the tool 21, an orientation being understood to mean the direction of a normal vector of a suction opening cross-sectional area delimited by the suction opening 45.

The tool 21 is accommodated in a reciprocating unit 31, whereby the reciprocating unit 31 is driven, at least rotationally, by the drive module 7. To supply an electric motor of the drive module 7 with voltage, a power connection 47, see FIG. 1, is located at the rear end, i.e., at the end of the housing 3 opposite the guiding unit 9.

The embodiment of the pressurized fluid dispensing assembly 25 shown in FIG. 4, the outlet area 29 of which is oriented as described above, also features a barrier device 49. The barrier device 49 is adapted to discharge gaseous pressurized fluid to provide a barrier fluid flow and comprises a discharge opening 51 oriented in the direction of the suction opening 45, wherein an orientation is understood to be the direction of a normal vector of a discharge opening cross-sectional area bounded by the discharge opening 51. In the embodiment shown, the barrier device 49 is connected via a further inlet area 50 to the pressurized fluid source 41 for supplying the barrier device 49 with pressurized fluid, wherein the discharge opening 51 and the further inlet area are fluidically connected via a barrier fluid channel 52. As an example, the barrier device 49 is integrated in the pressurized fluid dispensing assembly 25, wherein the inlet area 30 and the further inlet area 50 open out at a common outer surface 28 of the pressurized fluid dispensing assembly 25 and the pressurized fluid channel 32 and the barrier fluid channel 52 extend substantially parallel to each other.

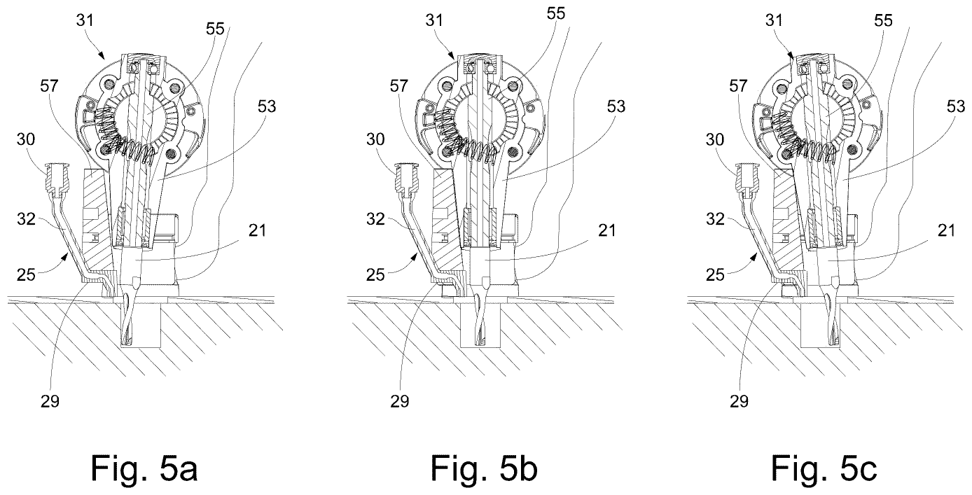

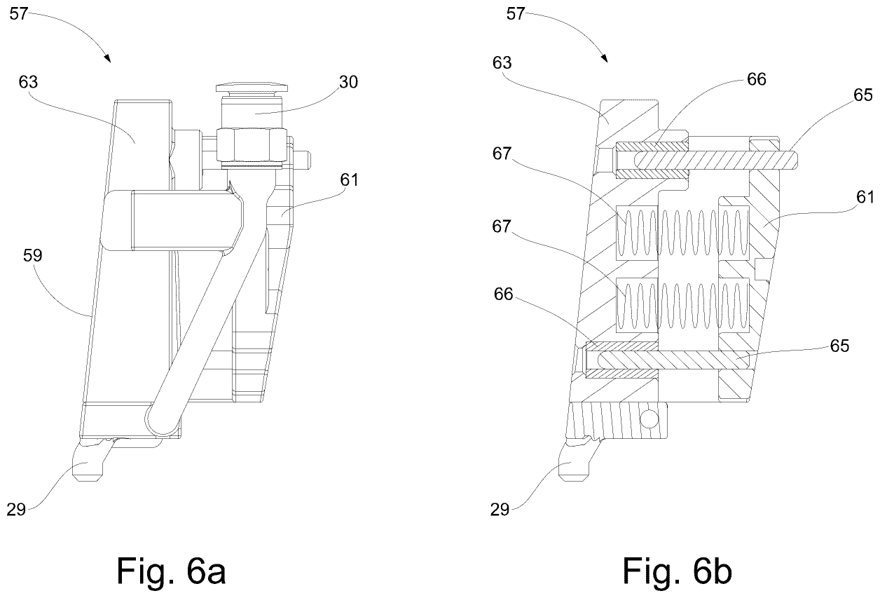

FIGS. 5a, 5b and 5c show an alternative reciprocating unit 31 and a third embodiment of the pressurized fluid dispensing assembly 25 of a second embodiment of the power tool 1, wherein the third embodiment of the pressurized fluid dispensing assembly 25 is shown in isolation in FIGS. 6a and 6b. The pressurized fluid dispensing assembly 25 features the outlet area 29 and the inlet area 30, which are fluidically connected via the pressurized fluid channel 32. In this embodiment, the inlet area 30 is designed as a plug connector which can be connected to a pressurized fluid hose, which is not shown, in order to connect the pressurized fluid dispensing assembly 25 to an external pressurized fluid source, which is not shown, for example in the form of a compressor, for supplying the pressurized fluid dispensing assembly 25 with pressurized fluid. The vacuum assembly 27 is designed as described above.

In this embodiment of the power tool 1, the drive module 7 is designed to set the reciprocating unit 31 in an operation motion in order to move the tool 21 relative to the workpiece. The reciprocating unit 31 comprises a spindle mount 53 executing the operation movement and a spindle 55 executing a rotational movement, wherein the spindle 55 is received in sections in the spindle mount 53. In the present embodiment example, the operation movement takes place periodically between the first position of the reciprocating unit 31 shown in FIG. 5a and the third position of the reciprocating unit 31 shown in FIG. 5c, wherein the second position of the reciprocating unit 31 shown in FIG. 5b is traversed during the operation movement. An operation movement is understood to be a movement relative to the workpiece or to the workpiece surface, wherein the movement relative to the workpiece surface comprises parallel and/or perpendicular components, wherein a movement amplitude parallel to the workpiece surface can be varied by means of the adjusting element 8.

In order to minimize a distance between the outlet area 29 and the tool 21 oriented parallel to the workpiece surface and to allow for the most effective possible dispense of pressurized fluid into the resulting cavity, the outlet area 29 is motion-coupled to the reciprocating unit 31, so that the outlet area 29 is set into an outlet area movement relative to the guiding unit 9 by the operation movement.

For the movement coupling between the outlet area 29 and the reciprocating unit 31, the pressurized fluid dispensing assembly 25 has a coupling unit 57 with a curve segment 59, whereby the spindle mount 53 is in contact with the curve segment 59 of the coupling unit 57. As an example, the curve segment 59 is designed to be flat, but can have further curves adapted to the operation movement of the reciprocating unit 31.

The illustrated coupling unit 57 is of multi-part design and comprises a bearing element 61, which is located in a fixed position in or on the guiding unit 9, and a displacement element 63, which is connected to the bearing element 61 via guide rods 65, which enable the displacement element 63 to be displaced relative to the bearing element 61. The guide rods 65 are mounted in bearing bushings 66 in the displacement element 63. In order to set the outlet area 29 into an outlet area movement relative to the guiding unit 9 by the displacement movement, the outlet area 29 is firmly connected to the displacement element 63. Springs 67 are located between the bearing element 61 and the displacement element 63, which enable the displacement element 63 to be returned to an initial position. If the spindle mount 53 performs an operation movement in the direction of the bearing element 61 up to the first position shown in FIG. 5a, the displacement element 63 is displaced along the guide rods 65 in the direction of the bearing element 61. If, after reaching the first position, the spindle mount 53 performs the opposite operation movement in the direction of the second (FIG. 5b) or third (FIG. 5c) position, the displacement element 63 is displaced away from the bearing element 61 along the guide rods 65 by the springs 67.

In the coupling unit 57 there are limit switches, not shown by way of example, which are connected in terms of signal technology to a control system provided in the power tool 1, not shown. When the first position is reached (FIG. 5a), i.e., when the limit switches respond, the control unit can cause the dispensing of pressurized fluid to stop. The dispensing of pressurized fluid is restarted when the spindle mount 53 leaves the first position again, so that the limit switches no longer respond.

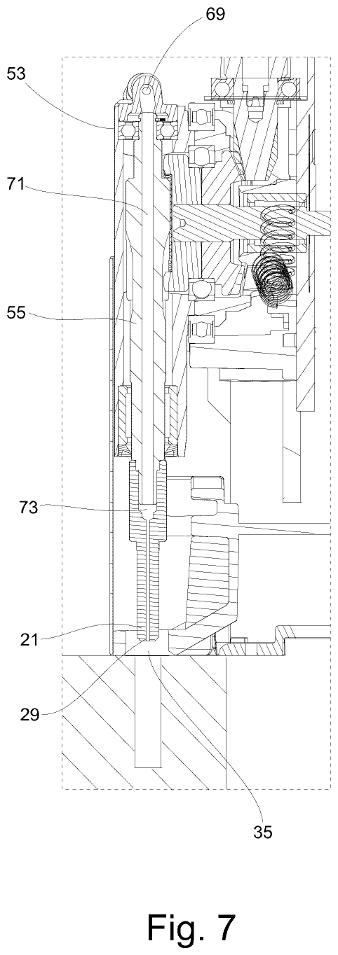

In a third embodiment of the power tool 1, partly shown in FIG. 7, the outlet area 29 has an outlet opening 35 opening out of the tool 21, so that pressurized fluid can be dispensed from the tool 21 directly into the resulting cavity in the workpiece to be machined. A channel 71, 73 is formed in each of the spindle 55 and the tool 21 for fluidical connection of the outlet opening 35 to the pressurized fluid source 41 or to a pressurized fluid conduit 69 connected to the pressurized fluid source 41, wherein the channels 71, 73 extend along the axial extension of the spindle 55 or the tool 21.

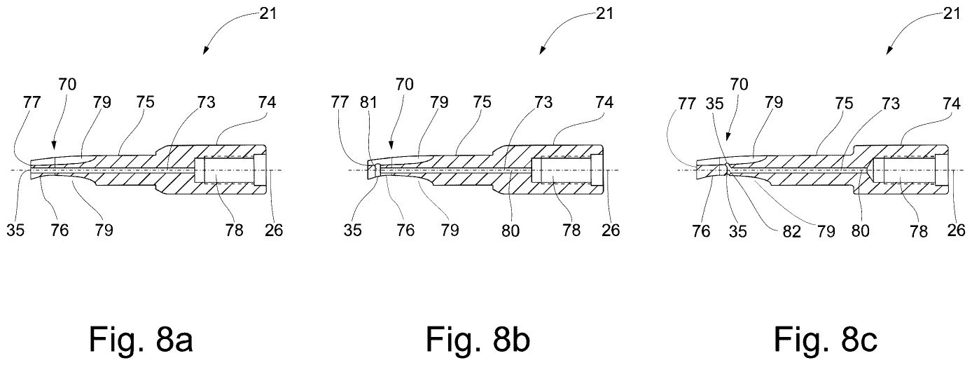

FIGS. 8a, 8b and 8c show various embodiments of a tool 21 designed as a tool for woodworking, more precisely as a wood milling cutter, for use with the embodiment of the power tool 1 shown in FIG. 7 in a sectional view. The embodiments of the woodworking tool shown each have two cutting edges 70 with corresponding chip spaces 79, whereby only one cutting edge 70 is visible in FIGS. 8a, 8b and 8c.

The tool 21 shown in FIG. 8a has a first tool segment 74, which is essentially cylindrical in shape, and a second tool segment 75 with a smaller diameter, which is adjacent to the first tool segment 74 and features for example in sections a cylindrical shape. At the region of the second tool segment 75 opposite to the first tool segment 74, a tool tip segment 76 is formed, which extends up to an end face 77 of the tool 21. The channel 73 of the tool 21 connects a pressurized fluid inlet chamber 78 of the tool 21 to the outlet opening 35. To connect the tool 21 to the spindle 55, the pressurized fluid inlet chamber 78 has, for example, an internal thread on its inner side, with the spindle 55 having an external thread corresponding to this internal thread.

In the embodiment example shown in FIG. 8a, the outlet opening 35 is located in the end face 77 of the tool 21. The channel 73 thus extends in a straight line from the pressurized fluid inlet chamber 78 to the outlet opening 35.

In the embodiment example of the tool 21 shown in FIG. 8b, the outlet opening 35 opens out of the tool 21 on the circumferential side. The channel 73 has a first channel section 80 located parallel to a central axis 26 of the tool 21 and a second channel section 81 aligned perpendicular to the first channel section 80, which fluidically connects the first channel section 80 to the outlet opening 35. In this embodiment, the pressurized fluid is dispensed perpendicular to the central axis 26 of the tool 21 into chip spaces 79 of the tool 21. In the present embodiment example, an outlet opening 35 is located in each chip space 79.

FIG. 8c shows another embodiment of the tool 21, wherein the tool 21 has outlet openings 35 located in chip spaces 79 of the tool 21. In the present embodiment, an outlet opening 35 opens into each chip space 79, wherein the outlet openings 35 are connected to each other and to a first channel section 80 via channel sections 82. The outlet openings 35 are oriented in such a way that the respective normal vector of an outlet opening cross-sectional area bounded by the respective outlet opening 35 has a component perpendicular to the central axis 26 of the tool 21 and a component parallel to the central axis 26 of the tool 21.

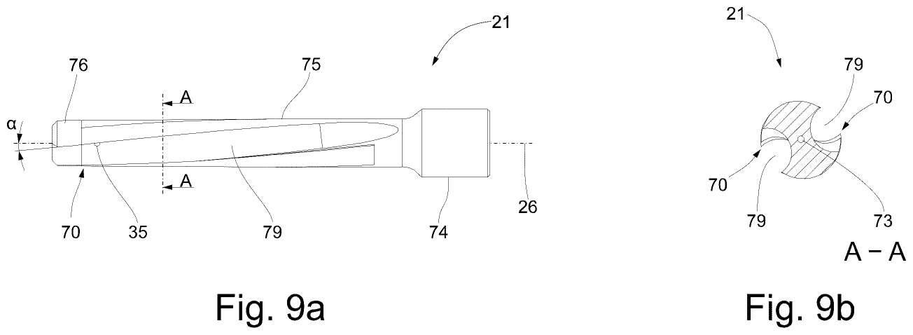

FIGS. 9a and 9b show a further embodiment of the tool 21 for use with the embodiment of the power tool 1 shown in FIG. 7. In this embodiment, two cutting edges 70 are formed which extend over a substantial area of the second tool segment 75. In this embodiment, the first tool segment 74 and the second tool segment 75 are made of a metallic base material and the tool tip segment 76 is made of cemented carbide. Outlet openings 35, which are formed in an area of the second tool segment 75 consisting of the base material, each opening into one of the chip spaces 79. A spiral angle & formed between the cutting edge 70 and the central axis 26 is constant over the entire extension of the cutting edges 70 in the embodiment of the tool 21 shown and is 11.5° in the shown example. The chip spaces 79 are formed corresponding to the cutting edges 70 on the second tool segment 75 and enable efficient chip removal from the workpiece to be machined.

1. A hand-held power tool, in particular woodworking tool, comprising:
a housing,
a handle for positioning the power tool relative to a workpiece,
a reciprocating unit for holding a tool for machining a workpiece,
a drive module located in the housing for driving the reciprocating unit, and
a pressurized fluid dispensing assembly having an outlet area for dispensing gaseous pressurized fluid into a working area of the tool during machining of the workpiece with the tool to purge the working area with the gaseous pressurized fluid,
a guiding unit with an abutment surface for abutment against the workpiece, wherein the pressurized fluid dispensing assembly is located on and/or in the guiding unit,
wherein the abutment surface has a recess through which the tool extends for machining the workpiece, wherein the outlet area of the pressurized fluid dispensing assembly is located in the area of the recess.

2. The hand-held power tool according to claim 1, further comprising the tool, wherein the tool serves to produce a cavity, in particular a hole and/or a groove, in the workpiece, and the pressurized fluid dispensing assembly serves to dispense the gaseous pressurized fluid into the resulting cavity during the production of the cavity to cause and/or assist a conveyance of workpiece particles from the resulting cavity.

3. The hand-held power tool according to claim 1, further comprising a vacuum assembly to extract workpiece particles from the working area.

4-5. (canceled)

6. The hand-held power tool according to claim 1, wherein the outlet area of the pressurized fluid dispensing assembly is fixed in position relative to, in or on the guiding unit.

7. The hand-held power tool according to claim 1, wherein the outlet area of the pressurized fluid dispensing assembly is movably arranged relative to, in or on the guiding unit.

8. The hand-held power tool according to claim 7, wherein the drive module is designed to set the reciprocating unit into an operation movement to move the tool relative to the workpiece.

9. The hand-held power tool according to claim 7, wherein the outlet area is at least temporarily motion-coupled to the reciprocating unit, so that the outlet area is set into an outlet area movement relative to the guiding unit by the operation movement.

10. The hand-held power tool according claim 1, wherein the reciprocating unit comprises a spindle mount executing the operation movement and a spindle executing a rotational movement, wherein the spindle is located at least in sections within the spindle mount.

11. The hand-held power tool according to claim 7, wherein the pressurized fluid dispensing assembly is motion-coupled to the spindle mount via a coupling unit, in particular a cam disk coupling.

12. A hand-held power tool comprising:
a housing,
a handle for positioning the power tool relative to a workpiece,
a reciprocating unit for holding a tool for machining a workpiece,
a drive module located in the housing for driving the reciprocating unit,
a pressurized fluid dispensing assembly having an outlet area for dispensing gaseous pressurized fluid into a working area of the tool during machining of the workpiece with the tool to purge the working area with the gaseous pressurized fluid, wherein the outlet area has an outlet opening which opens out of the tool, in particular out of a tool tip segment.

13. The hand-held power tool according to claim 12, wherein the tool is a woodworking tool, in particular a wood milling cutter.

14. The hand-held power tool according to claim 12, further comprising a pressurized fluid source fluidly connected to the pressurized fluid dispensing assembly and serving to provide the pressurized fluid to the pressurized fluid dispensing assembly.

15. The hand-held power tool according to claim 14, wherein the pressurized fluid source is located, in particular in a fixed position, in or on the housing or the guiding unit.

16. The hand-held power tool according to claim 14, wherein the pressurized fluid source comprises a fluid reservoir.

17. The hand-held power tool according to claim 16, wherein the fluid reservoir is designed as a replaceable cartridge.

18. The hand-held power tool according to claim 14, wherein the pressurized fluid source comprises a compressor.

19. The hand-held power tool according to claim 12, wherein the outlet area is arranged such that the outlet opening is oriented towards the workpiece and/or the resulting cavity.

20. A method for operating a hand-held power tool according to claim 1, comprising the steps of:
machining the workpiece with the tool in the working area,
dispensing pressurized gaseous fluid into the working area during machining of the workpiece with the tool to purge the working area with the pressurized gaseous fluid.

21. A tool according to claim 1 for woodworking, in particular wood milling cutter, having a channel extending along a central axis and an outlet opening fluidically connected to the channel for dispensing gaseous pressurized fluid into a working area.
